(19) United States
(12) Patent Application Publication
(10) Pub. No.: US 2019/0114700 A1
(43) Pub. Date: Apr. 18, 2019

(54) METHOD AND SYSTEM FOR SUPPLYING COMMODITIES

(71) Applicant: Shopping Cart Holdings Inc, New York, NY (US)

(72) Inventors: Mike Van Geldrop, New York, NY (US); Chris Schalenborgh, Maasmechelen (BE)

(21) Appl. No.: 16/163,127

(22) Filed: Oct. 17, 2018

Related U.S. Application Data
(60) Provisional application No. 62/573,580, filed on Oct. 17, 2017.

(30) Foreign Application Priority Data
Oct. 17, 2017 (GB) 1717064.8

(51) Int. Cl. G06Q 30/06; G06F 3/0481; H04L 29/06; G06K 9/00

(52) U.S. Cl. CPC G06Q 30/0643; G06F 3/04817; G06K 9/00456; H04L 63/0457; H04L 63/1483

(57) ABSTRACT

A system that is operable to communicate data within a data communication network, and that is operable to generate content including one or more images or videos and one or more symbols that are overlaid onto the one or more images or videos when a rendering of the content occurs on a graphical user interface, wherein the generation of the content reduces an amount of data needed to be communicated within the data communication network. The one or more symbols are user-selection executable via a user action at the graphical user interface. The one or more symbols when selected causes one or more software objects to be executed in the same rendering on the graphical user interface to cause a purchase of one or more associated commodities, in an event that the one or more commodities are in stock for delivery. The commodities relate to products or services, or both. The system enables commodities to be searched, purchased and supplied more efficiently (regarding data communication bandwidth employed) and with less user physiological fatigue in comparison to known systems. Optionally, the commodity is a supply of electrical power.

### TECHNICAL FIELD

The present disclosure relates generally to systems that provide arrangements that supply commodities; moreover, the present disclosure to methods of (for) employing aforementioned systems to provide arrangements that supply commodities. Moreover, the present disclosure relates to software products that are executable upon computing hardware for implementing aforesaid methods. Furthermore, aforementioned commodities include, for example products, services, raw materials, component parts, water supply, electricity supply, but is not limited thereto. Embodiments of the present disclosure are not “methods of doing business as such”, because the present disclosure is concerned with technical operation of systems, irrespective of a nature of commodities being handled by the systems, wherein technical operations of the systems are modified adaptively depending upon executing interactions associated with supplying commodities.

### BACKGROUND

Commodity supply systems, and methods of operating such commodity supply systems, have earlier been the subject matter of many granted patents; for example, a granted United Kingdom granted patent GB231277213, “Prepayment System” (Proprietor: Schlumberger Industries Ltd.) (granted April 1998) pertains to a prepayment supply system for electricity, gas or water comprises a prepayment token, typically a memory card or a smart card, into which credit data representative of an amount of credit or an amount of the commodity is entered by a vending machine in return for payment. The token is then inserted into a commodity supply control device, typically a meter, to enable the supply of an amount of the commodity determined by the credit data. The system includes simple vending machines, each of which communicates by phone with a system manager which periodically downloads a list of tokens requiring some kind of special action to the vending machines. On recognising a token on the list, the vending machine automatically performs the special action.

Since the 1990's, it will be appreciated that use of the Internet@ has grown appreciably, such that the aforementioned “token” described in the patent GB2312772B is now contemporarily implemented in a digital manner, but results in a same technical effect being achieved, namely payment for a commodity being implemented associated with delivering the purchase commodity to the user.

More recently, online retailers are offering, as a function of time, an increased range of goods and services for sale through web-based selling. This increased range has caused an increased popularity of shopping over the Internet®. Normally, when executing such Internet® shopping, a given customer may access multiple websites to view and choose commodities therefrom. The websites provide delivery and payment information to allow a successful purchase of such commodities. However, such conventional Internet® shopping amounts to “a method of doing business as such”, because a manner of operation of the Internet® is not modified by a nature of a financial transaction being performed. Indeed, conventional Internet® shopping potentially results in an increase in unnecessary Internet® data traffic, namely potentially slowing down Internet® response time for other Internet® users.

Contemporarily, a user makes a targeted purchase by categorically choosing a commodity, for example, by choosing a product or a product retailer from a web-based content; often, the web-based content may include either images or videos. Alternatively, the user may perform an unintended purchase, when surfing through a given example web-based content, without an a priori definite intention of buying any product therefrom. Generally, in a targeted purchase scenario, a user initially performs a general web-based search to locate a desired commodity. Thereafter, from displayed web-based content, the user selects the desired commodity. In such a process, the user is directed to a retailer website associated with the desired commodity, and the user may potentially have to navigate through multiple webpages for successfully making a purchase of the desired commodity. However, redirection and multiple webpage navigation often deviates user's interest from an initial webpage content that the user was viewing. This may be specific to a situation when the user is viewing the webpage without an a priori intention of buying any commodity therefrom. Accordingly, such a redirection may cause an unsatisfactory shopping and web browsing experience for the user. Therefore, such an unsatisfactory experience may lead to failure of successful purchases, which may affect revenue for retailers.

Therefore, in respect of known technology as described in the foregoing, there exist technical problems associated with conventional online shopping and web browsing associated therewith, wherein unnecessary data flow to the user occurs as a result of redirection, that consumes available data communication bandwidth and power in data communication networks such as the Internet®. Moreover, as aforementioned, in association with such aforesaid unnecessary data flow, a sub-optimal user experience may occur.

In a granted U.S. Pat. No. 9,697,563B2, “System and method for providing electronic commerce data” (Lux Inc.), there is described a method comprising:

retrieving, by a processing device, merchandise data from a plurality of independent merchants which is stored in a merchandise database;
consolidating the retrieved merchandise data into a common format;
making the merchandise database available to multiple publishers;
storing, by the processing device, at least one group of merchandise data formed in view of the merchandise data and content on a site of one of the multiple publishers;
embedding, by the processing device, the group of merchandise data on the content of the site of the one of the multiple publishers;
generating, by the processing device, one or more merchandise frames in view of the embedment;
rendering, by the processing device, the one or more merchandise frames directly onto the site of the one of the multiple publishers;
generating an e-commerce frame comprising merchandise data from the group of merchandise data that is selected by a user of the site of the one of the multiple publishers, wherein the e-commerce frame is a shopping bag of the selected merchandise data;
generating, by the processing device, a universal checkout frame that includes:
(i) a single order of multi-merchandise data comprising first merchandise data and second merchandise data that is selected from the one or more merchandise frames, wherein the first merchandise data corresponds to merchandise provided by a first independent merchant from the plurality of independent merchants, wherein the second merchandise data corresponds to merchandise provided by a second independent merchant from the plurality of independent merchants, and
(ii) an order summary of the multi-merchandise data comprising a name of the first independent merchant and a name of the second independent merchant; and
   rendering the universal checkout frame directly onto the site of the one of the multiple publishers.

### SUMMARY

The present disclosure seeks to provide an improved system that provides arrangements for supplying commodities, wherein the system, when in operation, generates content for assisting supply of one or more commodities, for example products or services, or both, associated with such content; it is sought to reduce amounts of data communicated via a data communication network when selecting the one or more commodities, to provide a faster interaction response to users. In other words, the present disclosure is concerned with adaptively configuring systems that provide arrangements for supplying commodities, wherein such adaptations include technically reconfiguring the systems. It is sought to reduce data amounts communicated via a data communication network when employing the system, for example selecting the one or more commodities, to provide a faster interaction response to users, as well as increasing data security during data exchanges.

The present disclosure also seeks to provide an improved method of (for) using a system that arranges supplying of commodities, wherein the method includes arranging for content to be generated to assist a supply of one or more commodities, for example products or services, or both, associated with such content; it is sought to reduce data amounts communicated via a data communication network when employing the method selecting the one or more commodities, to provide a faster interaction response to users, as well as increasing data security during data exchanges.

Data network operating regimes for reducing data flows have been the subject of numerous granted patents relating to communication codecs, and methods of encoding and decoding data; these patents are granted by the UKIPO, EPO and USPTO for example. However, reducing data flows results in remaining data that is communicated being more significant and therefore more vulnerable to potential malicious third-party eavesdropping and/or attack.

The present disclosure also seeks to provide a software product for implementing the aforesaid method.

The present disclosure also seeks to provide an improved graphical user interface (GUI) arrangement for use when arranging for a supply of commodities, for example products or services, or both.

In one aspect, there is provided a system that, when in operation, communicates data within a data communication network, and generates content including one or more images or videos, and one or more symbols that are overlaid onto the one or more images or videos when a rendering of the content occurs on a graphical user interface, wherein the one or more symbols are user-selection executable via a user action at the graphical user interface, wherein the generation of the content reduces an amount of data needed to be communicated within the data communication network, characterized in that the one or more symbols when selected causes one or more software objects to be executed in the same rendering on the graphical user interface to cause a purchase of one or more associated products, in an event that the one or more products are in stock for delivery, wherein the system includes a server communicably coupled to computing devices associated with a content publisher and a product retailer for generating the content.

The system is of advantage in that use of the one or more symbols that are user-selection executable for both stock checking purposes and purchasing purposes, namely in a “one touch” manner, avoids unnecessary web-pages being delivered to the user, thereby saving on data communication system bandwidth utilization.

The system is of advantage in that the generated content is optionally encrypted and/or obfuscated within the system, so that third-party malicious hacking of the system to redirect users to bogus or fraudulent web-sites does not occur. Optionally, the generated content, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

Moreover, the system is of advantage in that it improves user experience when making on-line purchases, for example by providing for more efficient data flows within a data network supporting operation of the system, for example by providing enhanced data security within the data network supporting operation of the system.

Optionally, the user action includes at least one touch action or click action to be performed on the graphical user interface for section of the one or more symbols. Such an “at least one touch action or click action” corresponds to the aforementioned “one touch” manner; “one touch” operation has been a subject matter of previous telecommunication patents, granted both by the EPO and the USPTO. Optionally, the “at least one touch action or click action” is communicated in an encrypted and thereafter obfuscated manner, for example as elucidated in the foregoing, to reduce a risk of third-party eavesdropping or corruption of procurement of commodities.

More optionally, the server, when in operation, directs a user device to the product retailer for providing information associated with a user to the product retailer.

Optionally, the server employs artificial intelligence algorithms (AI) to recognize the one or more associated products in one or more images or videos. Such AI can be regarded as being a form of control module, wherein electronic control modules in the past have been the subject matter of numerous granted patents before the EPO and USPTO. Artificial intelligence (AI) algorithms are capable of modifying their operating parameters in a dynamic manner, depending on data that has earlier been processed via the algorithms. For example, in an event of detected third-party hacking experienced by the server, the algorithms are adaptively able to modify a degree of data protection employed, for example by switching to using multiple iterations of encryption and/or obfuscation to make content even more difficult for third-parties to hack, even when using supercomputing or similar massive computing resources.

More optionally, the artificial intelligence algorithms are further operable to overlay the one or more symbols onto the recognized one or more products; however, it will be appreciated that the artificial intelligence algorithms perform other technical functions when implementing embodiments of the present disclosure. For example, the artificial intelligence algorithms can be used to determine characteristic nuances of users, for example dwell time between being presented with information and correspondingly reacting, such that an unexpected variation in such dwell time is potentially indicative of third-party hacking activities.

Optionally, the selection of the one or more symbols render a user-interaction window on a portion of the same graphical user interface, wherein the user-interaction window enables the purchase of the one or more associated products with the execution of the one or more software objects via the user action.

In another aspect, an embodiment of the present disclosure provides a method of using a system that, when in operation, communicates data within a data communication network, and generates content including one or more images or videos, and one or more symbols that are overlaid onto the one or more images or videos when a rendering of the content occurs on a graphical user interface, wherein the system includes a server communicably coupled to computing devices associated with a content publisher and a product retailer for generating the content, wherein the generation of the content reduces an amount of data needed to be communicated within the data communication network, characterized in that the method includes:
(i) arranging for the one or more symbols to be user-selection executable via a user action at the graphical user interface; and
(ii) arranging for the one or more symbols when selected to cause one or more software objects to be executed in the same rendering of the content on the graphical user interface to cause a purchase of one or more associated products, in an event that the one or more products are in stock for delivery.

The method is of advantage in that the generated content is optionally encrypted and/or obfuscated within the system, so that third-party malicious hacking of the system to redirect users to bogus or fraudulent web-sites does not occur. Optionally, the generated content, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

Optionally, in the method the user action includes at least one touch action or click action to be performed on the graphical user interface for section of the one or more symbols. Optionally, the method includes communicating the one touch action or click action in an encrypted and/or obfuscated manner, for example as aforementioned, to prevent third-party interference or hacking when employing the method.

More optionally, the method includes arranging for the server to direct a user device to the product retailer for providing information associated with a user to the product retailer.

Optionally, the method includes arranging for the server to employ artificial intelligence algorithms to recognize the one or more associated products in one or more images or videos. Optionally, the artificial intelligence algorithms are employed to detect variations in user responses that are potentially caused by third-party interference or hacking, wherein the artificial intelligence algorithms are change adaptively and dynamically a degree of data protection employed, for example by selectively increasing a number of iterations of encryption and/or obfuscation applied to data that is communicated when implementing the method. For example, a plurality of iterations of encryption an obfuscation is optionally employed to protect data when malicious third-party interventions are detected by the artificial intelligence algorithms. Such data protection, for example, is implemented using digital hardware whose operation is dynamically reconfigured depending upon a degree of third-party hacking that is experienced when implementing the method.

More optionally, in the method the artificial intelligence algorithms are further operable to overlay the one or more symbols onto the recognized one or more products.

Optionally, in the method the selection of the one or more symbols render a user-interaction window on a portion of the same graphical user interface, wherein the user-interaction window enables the purchase of the one or more associated products with the execution of the one or more software objects via the user action.

In yet another aspect, an embodiment of the present disclosure provides a software product recording on machine-readable data storage media, characterized in that the software product is executable upon computing hardware for implementing the aforesaid method.

In still another aspect, an embodiment of the present disclosure provides a graphical user interface arrangement for implementing content and its one or more symbols, together with one or more corresponding executable software objects when invoked by user selection of the one or more symbols, to provide for user action purchasing and delivery of one or more products associated with the one or more symbols overlaid upon images of the one or more products included in the content.

The graphical user interface is of advantage in that the generated content is optionally encrypted and/or obfuscated, so that third-party malicious hacking to redirect users to bogus or fraudulent web-sites does not occur. Optionally, the generated content, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

Optionally, in the graphical user interface (GUI), the selection of the one or more symbols render a user-interaction window on a portion of the same graphical user interface, wherein the user-interaction window enables the purchase of the one or more associated products with the execution of the one or more software objects via the user action.

In another aspect, an embodiment of the present disclosure provides a method of using a graphical user interface arrangement implemented with content including one or more images or videos, and one or more symbols that are overlaid onto the one or more images or videos, wherein the method includes:
(i) arranging for the one or more symbols to be user-selection executable via a user action at the graphical user interface; and
(ii) arranging for the one or more symbols when selected to cause one or more software objects to be executed in the same graphical user interface to cause a purchase of one or more associated products, in an event that the one or more products are in stock for delivery.

The method is of advantage in that the generated content is optionally encrypted and/or obfuscated, so that third-party malicious hacking to redirect users to bogus or fraudulent web-sites does not occur. Optionally, the generated content, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

Optionally, in the method of using the graphical user interface, the selection of the one or more symbols render a user-interaction window on a portion of the same graphical user interface, wherein the user-interaction window enables the purchase of the one or more associated products with the execution of the one or more software objects via the user action.

The system for supplying commodities of the present disclosure provides a graphical user interface (GUI) that enables seamless online shopping and web browsing associated therewith. Moreover, the graphical user interface enables a given user (such as online shoppers) to purchase a commodity from any piece of web content such as pictures, videos, blogs, and advertisements. Furthermore, the system enables the given user to purchase the commodity from any piece of web content without diverting the given user to a different webpage. Specifically, the system provides a graphical user interface (GUI) that partially overlays on the web content that the given user is viewing. Therefore, the system saves Internet® data traffic and also reduces data processing required in low-power portable browsing devices employed by the given users; such reduction of data processing is an important technical solution provided by embodiments of the present disclosure, and approaches to reduce power consumption in portable electronic devices has been the subject matter of many granted patents from the UKIPO, EPO and USPTO. Moreover, embodiments of the present disclosure are capable of making procurement of commodities via use of data communication networks more secure, by employing selective and adaptive ways of protecting commodity presentation data and corresponding commodity ordering data, thereby providing enhanced protection to malicious third-party hacking. Moreover, embodiments of the present disclosure are capable of providing an ergonomic benefit of being able to order commodities, for example products, more easily and with less frustration. For example, the seamless online shopping and web browsing may cause less frustration for elderly users with impaired cognitive abilities (e.g. partial dementia), wherein such elderly users may be less perceptive to potential third-party hacking and interference in their purchasing activities. Furthermore, the system provides a decrease in the number of websites accessed by a user; such system may be helpful for user with sight difficulties, because such system may cause less eyestrain and visual cortex processing. Various devices and apparatus for reducing toil and effort, as well as enhanced data security against third-party malicious attacks, have been granted patent protection by the UKIPO, EPO and USPTO for many years. For example, the UKIPO has granted patent for various encryption and decryption methods for many years.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for generating content, in accordance with an embodiment of the present disclosure;

FIGS. 2 and 3 are schematic illustrations of graphical user interfaces for implementing the content generated by the system of FIG. 1, in accordance with various embodiments of the present disclosure;

FIGS. 4A, 4B, 4C and 4D are schematic illustrations of a graphical user interface, in accordance with an embodiment of the present disclosure. Moreover, in FIG. 4B, 4C and 4D there is shown a user-interaction window overlaid on a portion of the graphical user interface.

FIG. 5 is an illustration of steps of a method of using a system for generating content, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a system for generating content including one or more images or videos, and one or more symbols that are overlaid onto the one or more images or videos when a rendering of the content occurs on a graphical user interface, wherein the one or more symbols are user-selection executable via a user action at the graphical user interface, wherein the one or more symbols when selected causes one or more software objects to be executed in the same rendering in the graphical user interface to cause a purchase of one or more associated commodities, in an event that the one or more commodities are in stock for delivery.

The system is of advantage in that the generated content is optionally encrypted and/or obfuscated within the system, so that third-party malicious hacking of the system to redirect users to bogus or fraudulent web-sites does not occur. Optionally, the generated content, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

The one or more commodities can include, for example, one or more of: raw materials, energy, products, components, services, but not limited thereto. For example, a given commodity is a product or a service, or a combination of both a product and a service; commodity supply devices, that are operable to vend against a payment being made, have been previously been allowed patent rights by the UKIPO, for example as in GB2312772B.

In another aspect, an embodiment of the present disclosure provides a method of using a system for generating content including one or more images or videos, and one or more symbols that are overlaid onto the one or more images or videos when a rendering of the content occurs on a graphical user interface, wherein the method includes:
(i) arranging for the one or more symbols to be user-selection executable via a user action at the graphical user interface; and
(ii) arranging for the one or more symbols when selected to cause one or more software objects to be executed in the same rendering on the graphical user interface to cause a purchase of one or more associated commodities, in an event that the one or more commodities are in stock for delivery.

The method is of advantage in that the generated content is optionally encrypted and/or obfuscated, so that third-party malicious hacking to redirect users to bogus or fraudulent web-sites does not occur. Optionally, the generated content, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

In another aspect, an embodiment of the present disclosure provides a graphical user interface arrangement for implementing content and its one or more symbols, together with one or more corresponding executable software objects when invoked by user selection of the one or more symbols, to provide for user action purchasing and delivery of one or more commodities associated with the one or more symbols overlaid upon images of the one or more commodities included in the content.

In another aspect, an embodiment of the present disclosure provides a method of using a graphical user interface arrangement implemented with content including one or more images or videos, and one or more symbols that are overlaid onto the one or more images or videos, wherein the method includes:
(i) arranging for the one or more symbols to be user-selection executable via a user action at the graphical user interface; and
(ii) arranging for the one or more symbols when selected to cause one or more software objects to be executed in the same graphical user interface to cause a purchase of one or more associated products, in an event that the one or more products are in stock for delivery.

The system is operable to generate content including one or more images or videos, and one or more symbols that are overlaid onto the one or more images or videos when rendered on a graphical user interface. Optionally, the term ‘system for generating content’ as used herein relates to an arrangement including programmable and/or non-programmable components that are configured to generate content that responds to user input. Optionally, the system generates content from the web-contents viewed and/or accessed by a user (such as a consumer) whilst browsing through the web pages available over the World Wide Web. Moreover, the web-content includes visual and/or textual content. For example, web content may be images, videos, animations, text and so forth. As aforementioned, the content is optionally subjected to various iterations of encryption and/or obfuscation when communicated to reduce a risk of successful third-party hacking or interference; corresponding de-obfuscation and decryption is beneficially employed when presenting the content to users. Such protection of data is beneficially implemented in a selective adaptive manner, depending upon a nature of a given user, a degree of risk experienced from malicious third-parties and/or a commercial value associated with commodities depicted by the content, for example.

Optionally, the images and videos included in the system for generating content are displayed on the website. Furthermore, the images and videos are contents published and/or uploaded by a content publisher. Optionally, the content publisher is any person, group, or organization that produces creates and uploads content onto websites. In an example, a content publisher may be a fashion blogger, who publishes images and videos related to latest style of clothes on a blog. In such an example, an image published by such fashion blogger may include a latest style of a jacket and a hat; such image may be considered by the system to generate content that responds to user input. In another example, a content publisher may publish content which when viewed by a user may be non-suggestive of performing a purchase; however, the user may use such content to perform an unintended purchase.

Furthermore, the web-content is viewed and/or accessed by the user on a user device. Optionally, the user device is a computing device associated with the user, such as a smartphone, a laptop, a tablet, a personal computer and so forth. Furthermore, the user device comprises general electronic components, such as an input means, an output means, a processer, a memory, a network adapter and so forth. Moreover, the user device may include an application program suitable for accessing and/or viewing web-content from web-pages. For example, the application program may include a web browser, such as GOOGLE CHROME® to access various websites, blogs, online advertisements and so forth.

Furthermore, the system includes a graphical user interface (GUI) that operates on the user device. Specifically, the graphical user interface is configured to render the one or more images or videos. Furthermore, the term “graphical user interface” in the context of the present disclosure relates to a visual display that enables the user to interact with the one or more images or videos render therein. Additionally, the graphical user interface (GUI) provides graphical indications that allow the user to interact with the user device. Optionally, graphical indications include visual elements that enable the user to provide input to the user device and receive output from the user device. Moreover, the graphical indications include icons, buttons, menus, toolbars, on-screen keyboards, control options, and other graphical screen elements. Optionally, the user interacts with the graphical user interface by providing keypad input, mouse input, gesture input, voice input, and so forth. For example, the user may interact with the graphical user interface displayed on the screen of the user device via a touch gesture. Furthermore, the graphical user interface (GUI) elements refer to visual objects that have a size and position in the graphical user interface (GUI). A graphical user-interface element may be visible, though there may be times when the user-interface element is hidden or overlaid on other user-interface elements.

Furthermore, the system includes one or more symbols that are overlaid onto the one or more images or videos when rendered on the graphical user interface (GUI). The term “symbol” in the context of the present disclosure relates to an indicium configured to respond to an input provided by the user. The symbols include any type of shape, art, graphic, picture, icon, number, label, letter, or any other appropriate element suitable for distinguishing a commodity, for example a consumer product, in the one or more images or videos. Specifically, the symbols are indicia overlaid on one or more commodities advertised on the one or more images or videos published by the content publisher. For example, an image published by a content publisher, such as a fashion blogger, on a blog may advertise a plurality of consumer products such as a jacket and a hat of latest style. In such an example, icons may be overlaid on the jacket and the hat indicating whether or not the jacket and the hat are susceptible to being purchased.

Optionally, the content publisher manually provides the system with information related to the overlaying of the one or more symbols onto the one or more images. Specifically, the information indicates a position of the one or more symbols to be associated with one or more commodities, for example one or more consumer products, advertised in the one or more images or videos. Optionally, it will be appreciated that the one or more commodities, for example consumer products, overlaid with symbols are items or entities available for online purchase. For example, a content publisher of a blog, such as a fashion blog, may upload an image to advertise a plurality of commodities, for example consumer products, such as a jacket and a hat. In such an example, the content publisher may provide the system with information to overlay symbols over the jacket and the hat, in order to identify the jacket and the hat as purchasable products. However, it will be appreciated that embodiments of the present disclosure are not limited to supply of consumer products, and, for example, relates to supply of resources such as energy, water and similar, for example as previously allowed for grant of patent rights before the UKIPO in GB2312772B.

Optionally, the content publisher provides the system with the information via a computing device associated with the content publisher. Optionally, it will be appreciated that the computing device associated with the content publisher is similar to the user device associated with the user. Additionally, the information provided by the content publisher to the system, for overlaying of the one or more symbols onto the one or more images is stored and processed in a server of the system. Such overlaying is, for example, capable of providing for considerable data reduction, for example data compression, thereby reducing an amount of data to be communicated via a data communication network when implementing embodiments of the present disclosure.

Optionally, the server is communicably coupled to computing devices associated with a content publisher and a product retailer for generating the content. Specifically, the server may be hardware, software, firmware or a combination of these, suitable for implementing the system. Furthermore, the server may include functional components, for example, a processor, a memory, a network adapter and so forth. In operation, the server is a data processing arrangement including various modules for generating content from the web-contents viewed and/or accessed by the user. Optionally, the server is communicably coupled to the user device.

Optionally, the server communicably coupled to computing devices associated with a content publisher and a product retailer via a communication network. Furthermore, the communication network may be an individual network, or a collection of individual networks, interconnected with each other and functioning as a single large network. Such individual networks may be wired, wireless, or a combination thereof.

Optionally, the server is configured to overlay the one or more symbols onto the one or more images or videos when rendered on a graphical user interface (GUI). Specifically, the server overlays the one or more symbols onto the one or more images or videos, in an event wherein the one or more commodities advertised in the one or more images or videos is provided by a commodity retailer for online purchase. Such overlaying is capable of providing a form of data compression in embodiments of the present disclosure by reducing a total number of images to be communicating via a data communication network; it will be appreciated that data compressors have been the subject matter of many granted patents before the UKIPO, EPO and USPTO.

Optionally, the commodity retailer is any person, group, or organization that offers one or more commodities for online sale. In an example, a commodity retailer may be a clothes designer that offers the clothes for online sale. In another example, a commodity retailer may be an organisation that offers the online sales of products provided by brick and mortar retailers. Additionally, the commodity retailer uses a computing device to offer one or more products and/or services for online sale. Furthermore, a commodity retailer may be associated with a plurality of computing device. Optionally, it will be appreciated that the computing device associated with the commodity retailer is similar to the user device associated with the user. Furthermore, the server is communicably coupled to the computing device associated with the commodity retailer to acquire information. Specifically, the information is related to the availability of one or more products and/or services offered for sales by the commodity retailer. Alternatively, the server may be operable to acquire the information related to the availability of one or more products and/or services from a web address. Optionally, it will be appreciated that the web address is a website or a web portal wherein the commodity retailer offers the one or more products and/or services for online sale.

Optionally, the server employs artificial intelligence (AI) algorithms to recognize the one or more associated commodities in one or more images or videos. The term “artificial intelligence algorithms” in the context of the present disclosure relates to software-based algorithms that are executable upon a computing hardware, such as the server, and are operable to adapt and adjust their operating parameters in an adaptive manner, depending upon information that is presented thereto when executed upon the computing hardware. Thus, by learning by example from a given content provider that manually defines where the one or more symbols are to be overlaid onto the one or more commodities in images or video to be rendered to a given user's graphical user interface (GUI), neural networks and variable state engines of the artificial intelligence (AI) algorithms are thereby programmed to perform such defining of where the one or more symbols are to be overlaid onto the one or more commodities in other images or video. Thus, it will be appreciated that generation of content pursuant to the present disclosure can be generated in a semi-automated or automated manner.

Optionally, the algorithms involve a decision tree or network defining decision states concerning whether or not to recognize one or more associated commodities (such as consumer products) advertised in one or more images or videos. Furthermore, weightings associated with the decision states are based on previous experiences of recognizing one or more commodities in the in one or more images or videos by the content provider; optionally, the experiences are aggregated across a plurality of content provider, as will be described in greater detail below.

The algorithms are operable to migrate between the decision states depending upon content presented to the algorithms, in operation. Moreover, the algorithms are operable to generate new decision states for new types of content that have not previously been provided to the algorithms, as detected using a matching function of the algorithms that compares a given type of content with another type of content. The matching function is optionally based upon a neural network that is trained against different types of content to differentiate therebetween; it will be appreciated that image recognition systems have previously been made the subject matter of many granted patents before the UKIPO, USPTO and EPO. For performing such a comparison of content, the content is processed to generate metadata, or pseudo-metadata, wherein the matching function is operable to determine a “distance” between the contents being compared, based at least in part upon the metadata or pseudo-metadata. For example, pseudo-metadata may be a combination of metadata parameters and a portion of the content being compared; the metadata may define the content that relates to a category of commodities in a given image wherein a portion of the content may relate to a shape or contour of an image included in the content.

Optionally, the artificial intelligence algorithms are operable to recognise one or more associated commodities advertised in the one or more images or videos. Additionally, the artificial intelligence algorithms are operable to recognise commodities, for example consumer products, in the one or more images or videos which are not identified by the content provider as being commodities. In an example, a content publisher such as a blogger, may upload an image on a blog, which advertises a male model wearing a hat, a jacket, a T-shirt, a pair of trousers and a pair of shoes. In such an example, the blogger may identify the hat, the jacket, and the pair of trousers as consumer products associated with the image. Furthermore, in such an example, the artificial intelligence algorithms may identify the T-shirt and the pair of shoes in the image as commodities associated with the image, along with the aforesaid commodities identified by the blogger.

Optionally, the artificial intelligence algorithms are operable to overlay the one or more symbols onto the recognized one or more commodities, for example as aforementioned. In an example, a blog such as a fashion blog, may be accessed by the user, additionally, the blog may include an image of a model wearing consumer product, namely a hat, a jacket, a T-shirt, a pair of trousers and a pair of shoes. In such an example, the content publisher of the blog may provide the system with the information related to the overlaying of the one or more symbols onto the hat, the jacket, and the pair of trousers to identify whether or not they are susceptible to being purchased. Furthermore, in operation of the system, the artificial intelligence algorithms optionally instruct the system to overlay one or more symbols onto the T-shirt and the pair of shoes, in order to provide an indication, namely to provide a “flag”, whether or not the pair of shoes is susceptible to being purchased, along with the aforesaid commodity identified by the content publisher as being susceptible to being purchased. It will be appreciated that granted patents for tools for inserting real physical labels into physical products have been known for many years, such tools attracting patent rights in UKIPO, EPO and USPTO; for example, inserting labels and antitheft devices into clothes products have been known and protected by patents for many years.

Additionally, the artificial intelligence algorithms are operable to overlay the one or more symbols onto the one or more commodities, for example products, based on the availability of a similar commodity for sale. Specifically, the artificial intelligence algorithms are operable to verify if a commodity retailer offers a commodity, similar to a recognised consumer commodity, for sale. For example, in an event, the artificial intelligence algorithms may determine that the commodity retailer offers the product, similar to the recognised commodity, for sale. In such an event, the artificial intelligence algorithms may overlay the one or more symbols onto the one or more commodities advertised in the one or more videos.

The one or more symbols are user-selections that are executable via a user action at the graphical user interface. Furthermore, the symbols are configured to execute in an event wherein the user performs a user action at the graphical user interface; for example, clicking a curser (for example, manipulating via use of a computer mouse, touch screen or tracker ball) is an example of such a user action. For example, a blog viewed by the user may include an image with one or more symbols overlaid on one or more associated consumer product advertised therein, when rendered on the graphical user interface. In such an example, the symbols function in the event wherein the user interacts with the symbols by providing an input through the graphical user interface.

Optionally, the artificial intelligence is operable to recognise commodities from digital contents viewed by the user and stored in the user device of the user. Furthermore, the artificial intelligence is operable to locate a commodity retailer that offers a commodity similar to the commodities and thereafter overlay symbols on the recognised commodities, to enable purchasing of the commodity, for example product. It will be appreciated that image recognition systems and matching have earlier been the subject matter of many granted patents relating to automated surveillance systems, these patents having been granted by the UKIPO, EPO and USPTO.

Optionally, the term “user action” in the context of the present disclosure relates to an input provided by the user to interact with the content generated by the system. Furthermore, the user action is the input that the user provides the system via the graphical user interface (GUI). Additionally, the user action includes any appropriate input provided by the user suitable for interacting with the content generated by the system (namely, the one or more images or videos of the web-pages accessed by the user) with the one or more symbols overlaid on the one or more commodities, for example consumer products, advertised on the one or more images or videos of the web-pages. Optionally, the user action includes at least one touch action or click action to be performed on the graphical user interface for selection of the one or more symbols, for example as aforementioned using an mouse, a touch screen or a tracker ball pointing device.

Optionally, the user action includes at least one touch action or click action to be performed on the graphical user interface for selection of the one or more symbols. Optionally, the one touch action is performed by the user by providing a touch gesture on a touch sensitive display of the user device rendering the graphical user interface. In an example, the graphical user interface may overlay symbol on a commodity, for example a consumer product, advertised on an image of a website, wherein the website may be accessed by the user via the user device. In such example, the user may perform a one touch action by providing a touch sensitive screen of the user device with a touch gesture to select the symbol. Optionally, the click action is performed by the user by providing the input to the graphical user interface by navigating elements of the graphical user interface. In an example, the graphical user interface may overlay a symbol on a commodity, advertised on an image of a website, wherein the website may be accessed by the user via the user device. In such example, the user may navigate a cursor or pointers displayed on the graphical user interface and select the symbol via a peripheral device such as a mouse or an external keypad.

The one or more symbols when selected causes one or more software objects to be executed in the same graphical user interface to cause a purchase of one or more associated products, in an event that the one or more commodities are in stock for delivery. Optionally, the one or more software objects are application programs associated with the one or more symbols. Additionally, the one or more software objects are a set of instructions stored on a computing hardware such as the user device, configured to perform a specific function. Furthermore, the one or more software object associated with the one or more symbol may be operable to generate an additional part in the same graphical user interface (GUI) to enable a user to purchase a commodity associated with the symbol.

Optionally, the selection of the one or more symbols renders a user-interaction window on a portion of the same graphical user interface. Specifically, the user-interaction window is configured to displayed the commodity that is associated with the one or more symbols. In an example, the user-interaction may slide onto the graphical user interface. Additionally, in an event wherein a symbol is selected on a video rendered on the graphical user interface, the video is looped or stalled when the user-interaction window is displayed on the same graphical user interface.

Furthermore, the user-interaction window enables the purchase of the one or more associated commodities with the execution of the one or more software objects via the user action. Additionally, the user-interaction window displays an interface including input fields wherein the user may provide various option related to the purchase of the one or more associated products. For example, the user-interaction window may include input fields wherein the user may select the number of commodities, the size of commodities (for example, electrical power to be delivered, metal sheet to be delivered, welding rods to the delivered), the shape of commodities, the colour of commodities and so forth. It will be appreciated that embodiments of the present disclosure are concerned with underlying systems and their operation supporting supply of commodities, not the process of merely buying products that represents a method of doing business. The system, in its manner of operation, results in a reduction of data that needs to be communicated within a data network supporting operation of the system, and also reduces fatigue to the user when organizing supply of one or more commodities. Apparatus for reducing human labour and fatigue have been protected by patents for many years, wherein the patents have been issued by the UKIPO, EPO and USPTO. For example, various labour-saving kitchen apparatus have been protected by patents in UKIPO and EPO for vey many years.

In an exemplary implementation of the present disclosure, when a given user invokes one or more symbols, overlaid onto an image on a graphical user interface, then one or more corresponding user interaction windows are rendered on a portion of the same graphical user interface. Notably, the given user interaction window refers to a transaction window associated with a given retailer's website which provides details of the one or more products associated with the symbol. The details pertaining to the one or more products include, but are not limited to, detailed description of the one or more products, information pertaining to ratings and reviews of the one or more products, types of shipping available for the one or more products, price details and offers related to the one or more products. The user may directly proceed to transact with the retailer's website via the user interaction window. Specifically, in order to proceed with transaction via the user interaction window, the user is required to provide shipping details (for example, such as a user's name, user's email address, street address, zip code, city, country name, contact details), type of shipping (for example, such as express, fast or normal). More specifically, the user provides such details relating to the transaction via the same user interaction window. Moreover, the user completes the transaction by selecting a mode of payment via the same user interaction window. In other words, the user completes the transaction by:
(i) selecting a mode of payment via a same user interaction window; or
(ii) being shown a link to a retailer web-site for making a payment; or
(iii) by employing by performing a checkout via a proprietary plugin, but a plurality of (i) to (iii) are not employed concurrently.
   Such an implementation of the system enables the user to purchase the commodity from any piece of web content, without being redirected to a different webpage, for example. The system also addresses the technical problem of data flows within data communication networks and also speeds the operation of the data communication networks for implementing given user-defined tasks.

Optionally, the data flows are encrypted and/or obfuscated, so that third-party malicious hacking to redirect users to bogus or fraudulent web-sites does not occur. Optionally, the generated content, for example web-site graphical information, when communicated, is encrypted to generate encrypted data that is then obfuscated by bit, nibble or byte swapping according to an obfuscation template to generate corresponding obfuscated encrypted data for communication; upon receipt of the obfuscated encrypted data, for presenting the generated content to a given user, the obfuscated encrypted data is processed by de-obfuscation using the obfuscation template to generate de-obfuscated encrypted data, and then subjecting the de-obfuscated encrypted data to decryption to regenerate the content. Optionally, the obfuscation template is adaptively selected from a plurality of potential obfuscation templates, depending on one or more of:
(i) one or more characteristics of the given user;
(ii) a technical nature of the content; and
(iii) a commercial value associated with one or more commodities represented by the content.

Optionally, in the event wherein the user opts to purchase a given commodity, the server verifies if a commodity retailer has the commodity available in its store and offers the commodity for sale. Furthermore, in the event wherein, the server authenticates that the commodity is available for sale, the server is operable to direct a user device to the commodity retailer for providing information associated with a user to the commodity retailer. Optionally, it will be appreciated that the server is operable to verify the availability of the commodity from information provided by the commodity retailer about the available commodity. Furthermore, the server is operable to verify the availability of the commodity by accessing a website associated with the commodity retailer, for acquiring the information related to the commodity that the commodity retailer is offering for sale. By such a process, it will be appreciated that multiple data communications are made in a data network, for example the Internet®, supporting operation of the system. Reducing a data flow associated with the multiple data communications is an important technical advantage provided by the system. As a result, the system is capable of being more temporally responsive.

Optionally, the server is operable to direct a user device to the commodity retailer for providing information associated with a user to the commodity retailer. Specifically, the server is operable to provide the user-interaction window including a purchase webpage associated with the commodity retailer. Furthermore, the purchase webpage includes input fields to accept information associated with the user. Additionally, the information associated with the user includes payment information, delivery information and so forth. In an example, a user accessing the purchase webpage of the commodity retailer for purchasing a commodity may provide information related to the preferred location of delivery, a preferred date and time of delivery, a mode of payment information and so forth. Apparatus for supplying a commodity against payment have previously been patented by the UKIPO, for example as in patent GB2312772B.

Furthermore, there is provided a software product recording on machine-readable data storage media, characterized in that the software product is executable upon computing hardware for implementing a method of using a system for supplying commodities; the software product, when executed, enables commodities to be supplied via use of a data communication network with a need for less data flow and greater temporal responsiveness to users.

The present description also relates to the method as described above. The various embodiments and variants disclosed above apply mutatis mutandis to the method.

### DETAILED DESCRIPTION OF THE DRAWINGS

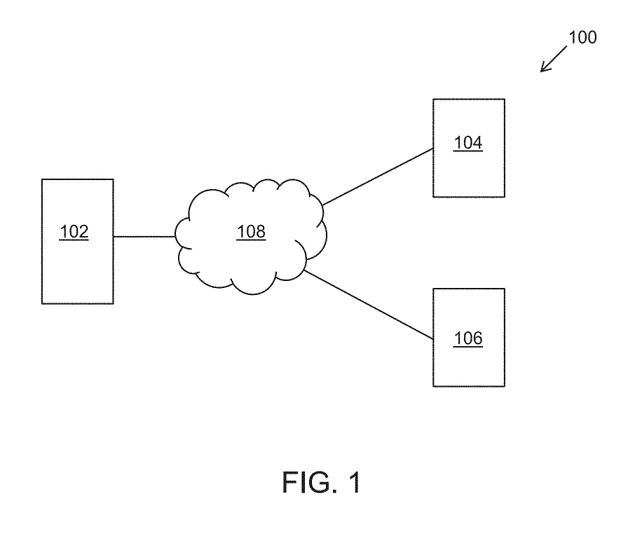

Referring to FIG. 1, there is illustrated a block diagram of a system 100 for supplying commodities, in accordance with an embodiment of the present disclosure. As shown, the system 100 includes a server 102, at least one computing device, such as a computing device 104, associated with a content publisher, and at least one computing device, such as a computing device 106, associated with a commodity publisher, for example product publisher. The server 102 is communicably coupled to the computing device 104 and the computing device 106 via a data communication network 108. The data communication network is optionally implemented via use of the Internet®. Moreover, it will be appreciated that use of the system 100 results in considerable data flows within the data communication network, especially when the data flow is associated with many detailed video or still images. In operation, the system 100 is capable of resulting in a reduction in the data flows, namely providing in effect a form of data compression in association is providing a platform for organizing a supply of one or more commodities.

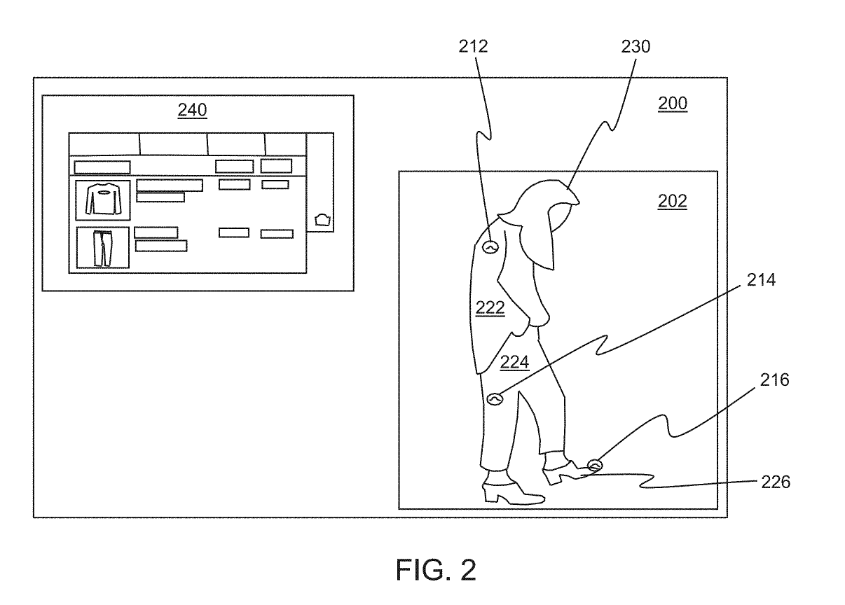

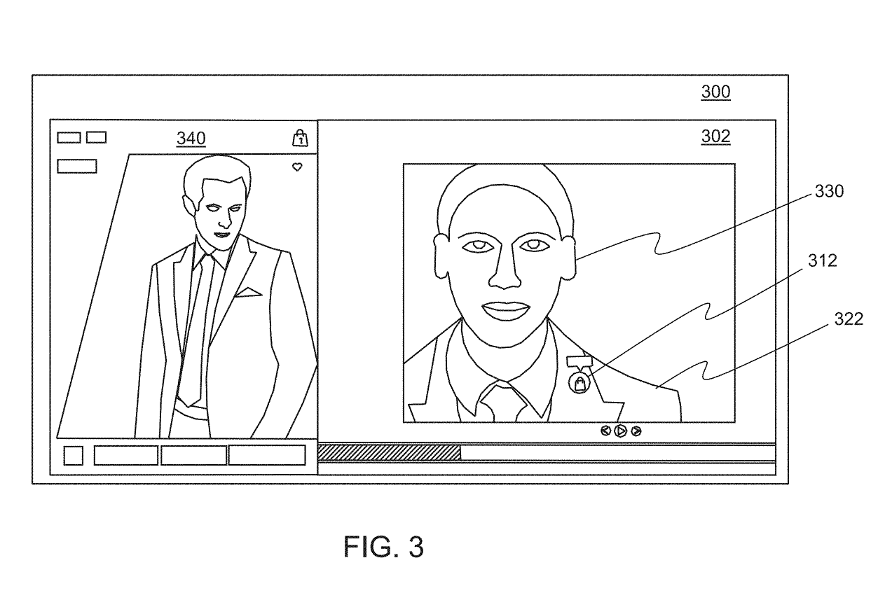

Referring to FIGS. 2 and 3, there are depicted schematic illustrations of graphical user interfaces (GUI's) 200 and 300 for implementing content generated by the system 100 of FIG. 1, in accordance with various embodiments of the present disclosure. The graphical user interfaces 200, 300 are to be rendered on a computing device (not shown) associated with a user (or buyer) that may use the system 100 of FIG. 1 for making purchase of one or more commodities, for example products or services, or both, shown in the content generated by the system 100.

In FIG. 2, there is depicted an illustration of the graphical user interface 200 that includes the system generated content, such as an image 202, and one or more symbols, such as symbols 212, 214 and 216, overlaid onto the image 202. As shown, the symbols 212, 214 and 216 are associated with one or more commodities, such as a shirt 222, a trouser 224 and a shoe 226 worn by a lady 230, in the image 202. The graphical user interface 200 also includes a user-interaction window 240 on a portion of the same graphical user interface 200. The user-interaction window 240 enables a selection of the symbols 212, 214, 216 to be performed to assist the user (of the computing device rendered with the graphical user interface 200) to make seamless purchase of the commodities, such as the shirt 222, the trouser 224 and the shoe 226, overlaid with the symbols 212, 214, 216, respectively. The seamless purchase is performed in a “one-touch manner”, as described in the foregoing; such a “one-touch manner” reduces a need for so many screen refreshes to be performed that reduces user fatigue; moreover, a need to supply data via a data communication network for performing such page refreshes is avoided, thereby reducing data traffic in communication networks.

It will be appreciated that other types of commodities are susceptible to being purchased and supplied, for example a quantity of water, a quantity of electricity, a quantity of waste disposal, a quantity of heating (for example, supplied from a district heating system), a taxi journey, an aircraft flight, timber for a building project, and so forth. Moreover, it will be appreciated that the system 100 can be used in an industrial manufacturing environment for obtaining a supply of components and materials for manufacturing activities; in other words, the system 100 can be regarded as another “machine” within a manufacturing environment that enables convenient an efficient procurement of commodities for manufacture, by reducing communication bandwidth utilization and human fatigue when assessing suppliers. Devices for reducing human fatigue, as a technical effect, are regularly the subject matter of granted patents.

Similarly, in FIG. 3, there is shown a depiction of the graphical user interface (GUI) 300 that includes the system-generated content, such as a video 302, and one or more symbols, such as symbol 312, overlaid (or appearing) on the video 302. As shown, the symbol 312 is associated with one or more commodities, such as a blazer 322 worn by a gentleman 330, in the video 302. The graphical user interface 300 also includes a user-interaction window 340 on a portion of the same graphical user interface 300. The user-interaction window 340 enables selection of the symbol 312 to assist the user (of the computing device rendered with the graphical user interface 300) to make seamless purchase of the commodity, such as the blazer 322, overlaid with the symbols 312.

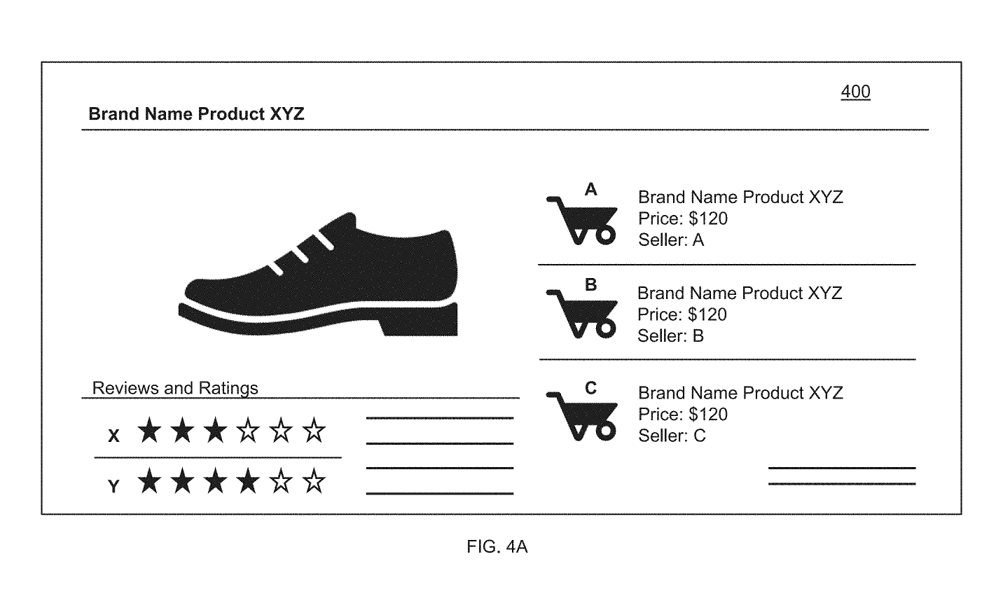

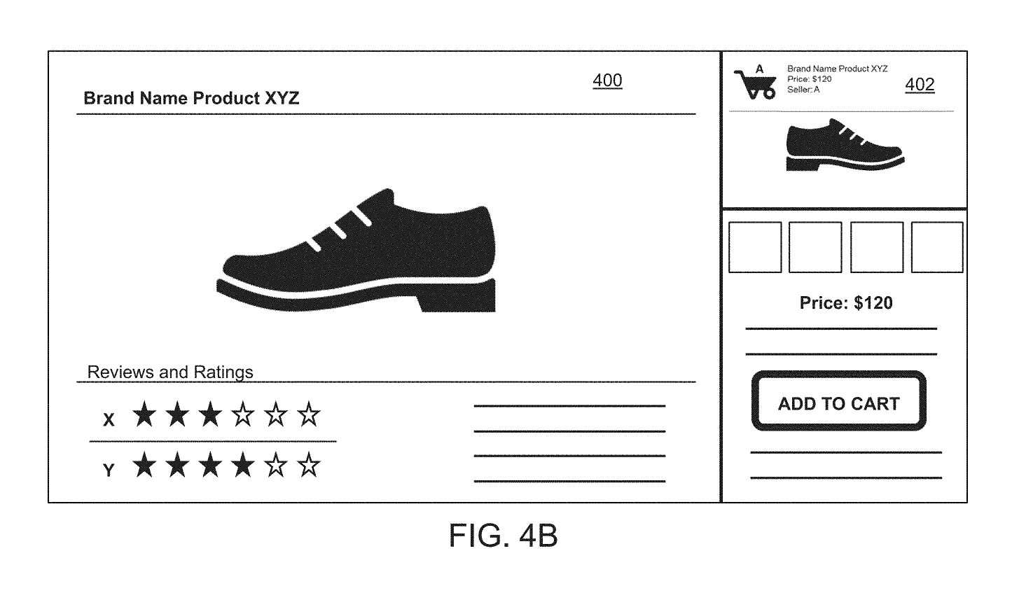

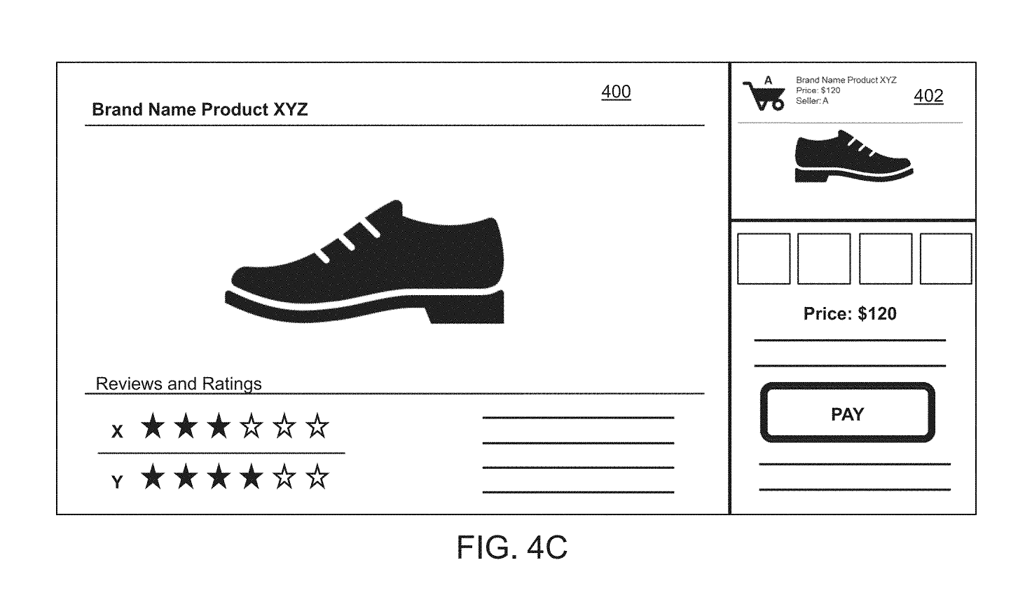

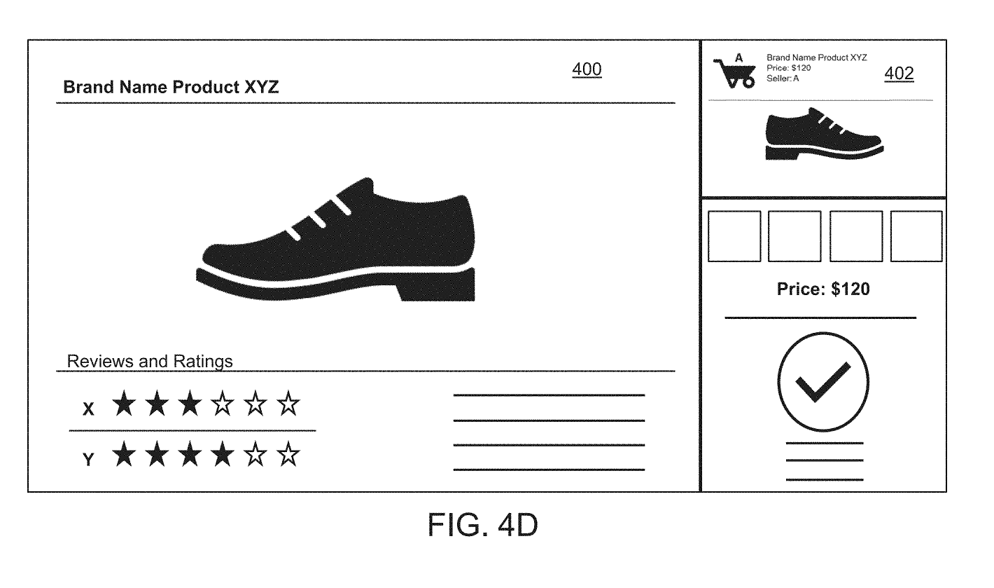

FIGS. 4A, 4B, 4C and 4D are schematic illustrations of a graphical user interface 400, in accordance with an embodiment of the present disclosure. Moreover, in FIG. 4B, 4C and 4D there is shown a user-interaction window 402 overlaid on a portion of the graphical user interface.

In FIG. 4A, there is shown an example of a graphical user interface. The graphical user interface 400 enables a given user (such as online shoppers) to purchase a commodity from any piece of web content such as pictures, videos, blogs, and advertisements. With reference to FIG. 4B, 4C and 4D, there is shown a user interaction window 402 rendered on a portion of the same graphical user interface 400. The user interaction window 402 enables purchase of one or more associated commodities, via execution of the one or more software objects via the user action. The user interaction window 402 is rendered when a given user invokes one or more symbols, overlaid onto an image on a graphical user interface 400. Subsequently, the given user may complete the purchase of one or more associated commodities using the user interaction window 402, without being redirected to a different webpage.

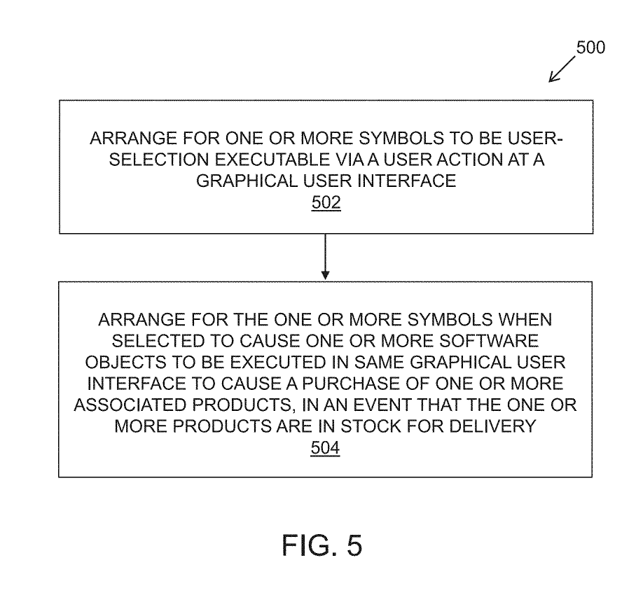

Referring next to FIG. 5, there are illustrated steps of a method 500 of using a system for supplying commodities, in accordance with an embodiment of the present disclosure. It will be appreciated that the system of the method 500 corresponds to a system, such as the system 100, explained hereinabove in conjunction with FIGS. 1 to 3. For example, the system, when implemented the method 500, generates content including one or more images or videos, and one or more symbols that are overlaid onto the one or more images or videos when rendered on a graphical user interface (GUI). Moreover, the system executes many other tasks in addition that enable the method to have a technical effect.

At a step 502, the one or more symbols are arranged to be user-selection executable via a user action at the graphical user interface (GUI). At a step 504, the one or more symbols when selected to cause one or more software objects to be executed in the same graphical user interface (GUI) are arranged to cause a purchase of one or more associated commodities, in an event that the one or more commodities are in stock for delivery, or are susceptible to being delivered (for example, services).

The steps 502 to 504 are only illustrative and other alternatives can also be provided where one or more steps are added, one or more steps are removed, or one or more steps are provided in a different sequence without departing from the scope of the claims herein. For example, in the method 500, the user action includes at least one touch action or click action to be performed on the graphical user interface (GUI) for section of the one or more symbols; such at least one touch action or click action avoids a need to navigate through multiple data screens, thereby reducing data processing load and reducing an amount of data needing to be communicated via data communication networks and stored within data memory of computing devices supporting the method 500. In another example, the method 500 includes arranging for the system to include a server communicably coupled to computing devices associated with a content publisher and a product retailer for generating the content. Optionally, the method 500 includes arranging for the server to direct a user device to the commodity retailer for providing information associated with a user to the commodity retailer. More optionally, the method 500 includes arranging for the server to employ artificial intelligence (AI) algorithms to recognize the one or more associated commodities in one or more images or videos. Yet more optionally, in the method 500, the artificial intelligence (AI) algorithms are further operable to overlay the one or more symbols onto the recognized one or more commodities. In an example, in the method 500, the selection of the one or more symbols renders a user-interaction window on a portion of the same graphical user interface, wherein the user-interaction window enables the purchase of the one or more associated commodities with the execution of the one or more software objects via the user action. It will be appreciated that the artificial intelligence (AI) algorithms are also optionally employed to enhance data security by recognizing characteristic patterns of user-interactions, such that deviations of user-interaction parameters exceeding one or more thresholds results in a third-party interference being detected, such that information associated with the one or more commodities, and also user-purchasing of the one or more commodities is encrypted and/or obfuscated adaptively to a high degree of protection. When third-party hacking or interference is not detected, data communication can be less robustly protected, for ensuring a fastest communication and rendering of data on the graphical user interface, to provide for a more responsive user experience.

In the foregoing description of embodiments of the present disclosure, it will be appreciated that the system 100 optionally employs one or more Application Program Interfaces (API's), but use of such API's is not mandatory for implementing embodiments of the present disclosure. Thus, the system 100 is optionally capable of functioning devoid of API's needing to be executed. Thus, a given user invoking the symbols 212, 214 and 216, overlaid onto the image 202, optionally causes one or more corresponding API's to be launched, alternatively merely invokes a link to be opened to another Internet® website providing an information feed. Avoiding a need for API's, for example by using plug-ins, has a technical advantage in that there is a reduced a risk of API's being invoked concurrently and mutually interacting to cause unexpected results within the system 100. Thus, avoidance of use of API's potentially makes executing of the system 100 more stable on computing hardware. Stability of operation of computing hardware has previously been the subject matter of granted patents before the UKIPO, EPO and USPTO.

Optionally, the system 100 is operable to employ an auto-scanning tool for identifying commodities and representing corresponding commodity retailers via use of symbols on the graphical user interface (GUI) 300. Optionally, such an auto-scanning tool employs artificial intelligence (AI) hardware or software, or both. Such hardware relates, for example, to neural networks and pseudo-analog variable state machines, for example implemented using digital logic (for example ASIC's hosted at an Internet® server) or a combination of digital hardware and software. Optionally, the system 100 is implemented to be agnostic (namely impartial) to affiliates, commodity retailers and publishers that are involved with the system 100 and are represented by symbols in the graphical user interface (GUI) 300; such impartiality is achieved by arranging for the system 100 to normalize all its commodity and commodity retailing data, for example using translation algorithms that are individually adapted for corresponding commodity retailers.

Depending upon Internet® communication bandwidth, data feed rate from servers of commodity retailers, the system 100 is optionally operable to provide a “fast queue”, namely to prioritize certain symbols of the graphical user interface (GUI) 300 relative to other symbols, wherein the prioritized symbols are arranged to be updated more frequently and respond more rapidly than the other symbols, in order to provide users with a more temporally prompt response from the system 100, thereby reducing user fatigue when employing the system 100.

In the system 100, details representative of commodities, for example product or services, or both, are maintained periodically up to date, for example on a daily basis or on a weekly basis, because it is misleading and irritating for users of the system 100 to be shown out-of-stock commodities, because such an irritation corresponds to a sub-optimal user experience when using the system 100, especially when checking out to pay for selected commodities via use of the graphical user interface (GUI) 300; such updating occurs via data communication in a data communication network that is configured to support operation of the system 100. By selective updating, aforementioned data flows within the system 100 can be reduced (namely, a form of data compression is achieved in the system 100 by way of its manner of operation). Reduction of data flows, namely data compression, has previously been the technical aim of many codecs that have been protected by patents before the UKIPO, EPO and USPTO. Thus, when a given commodity is selected by a given user for potential purchase, the given commodity is prioritized, for example in a manner as described in the foregoing, and information regarding the selected product is updated more frequently, relative to prior to the given commodity being selected, for example every few minutes instead of usual daily updating. Optionally, the system 100 employs an algorithm, wherein commodity information, for example product information, is updated with a frequency that is a function of how frequently the given commodity is selected by various users of the system 100. Optionally, mutually different update rates are employed within the system 100 for different categories of commodities; for example, commodity information is updated more frequently for perishable commodities in comparison to temporally stable commodities, for example commodities that do not change their state from week-to-week.

In operation, the system 100 is operable to generate a commodity procurement regime, referred to as being a commodity “ecosystem”, by employing at least one of a plurality of methods of supplying data to the system 100:
(i) via data feeds from commodity retailers, or their respective commodity-supplying affiliates:
(ii) via optional use of one or more aforementioned API's, wherein the one or more API's are provided by commodity retailers, or their respective commodity-supplying affiliates; and
(iii) via optional use of one or more data scrapers, wherein the one or more data scrapers are robotic software-based devices that acquire data by performing roaming operations within a data communication network, for example the Internet®.

Optionally, the graphical user interface (GUI) 300 is operable to organize groups of commodity retailers into “web shops”, as experienced by the user when employing the system 100, wherein:
(i) commodity retailers of a given group are normalized into one or more categories; or
(ii) their commodities are organized into one or more categories; or
(iii) information regarding their commodities are organized into one or more categories.

Optionally, the categories are identified and proposed by the aforementioned artificial intelligence algorithms, for example as a function of demand for commodities, a frequency of availability of commodities from suppliers, a degree of temporal perishability of the commodities, one or more technical properties of the commodity and so forth. Such one or more technical properties pertain, for example, to a reliability of supply of electric power from an electrical power grid. Such categorization can be implemented throughout the aforementioned “ecosystem”, or customized to individual users of the system 100; for example, a given user is able to browse:

### Women>Dresses

wherein the system 100 is operable to provide data to the given user via the graphical user interface (GUI) 300 pertaining to all dresses that are potentially available for purchase from all commodity suppliers associated with the system 100.

Although an example of “dresses” is provided above, it will be appreciated that the commodity is alternatively electrical power supply, with certain quality parameters associated therewith, such as temporal voltage fluctuation, a risk of potential blackout, a temporal maximum power limit that is available to users, temporal variation in cost of electricity, and so forth, for example for providing a flexible energy supply market. A technical effect thereby achieved is a potential assurance of commodity supply reliability, namely known risk of blackout or brownout to the user.

The system 100 is arranged to employ a checkout engine when in operation. This checkout engine will next be elucidated in greater detail. The checkout engine is very straightforward to use and therefore reduces user fatigue and a need to refresh so many pages of information on the graphical user interface, namely results in reduced processing power and less data flows within the system 100. Such reduction in data flows is susceptible to improving a temporal responsiveness of the system 100 when in operation.

The system 100, as aforementioned, is operable, namely configured, to provide an “ecosystem” for supplying selected commodities, wherein the supply is arranged with various technical benefits such as reduced Internet® bandwidth requirements and less user fatigue when searching, selecting and ordering commodities, as aforementioned.

The system 100 beneficially provides a universal checkout “ecosystem”, referred also as being a “checkout engine”. Optionally, the checkout engine employs one or more aforementioned API's, but use of API's is not mandatory in the system 100, as aforesaid. In the system 100, each commodity retailer beneficially employs a method including following steps:
Step S1: for each commodity retailer, for example from their commodity retailing Internet® site, requesting and receiving shipping information, wherein such shipping information pertains to expected delivery cost, commodity supply policies and similar, for example;
Step S2: for each commodity retailer, requesting and receiving shipping method information, for example based upon billing information, shipping information and user cart contents; such shipping method information is optionally submitted to the commodity retailer via an affiliate link;
Step S3: setting the commodity shipping method within the system 100 and submitting corresponding information to an Internet® website of the selected commodity retailer;
Step S4: setting payment information within the system 100 and submitting corresponding information to the Internet® website of the selected commodity retailer;
Step S5: placing an order for supplying the selected commodity, wherein placing the order involves communicating information (data) corresponding to steps S1 to S4 above to the Internet® website of the selected commodity retailer;
Step S6: optionally, monitoring internal mailboxes of the system 100 for any order-related e-mails, and forwarding these to the user; optionally, newsletters and such promotional content is not forwarded to the user in order to reduce data flows occurring within the system 100 and thereby improving its temporal responsiveness when in operation.

Beneficially, as aforementioned, one or more API's are optionally used to combine information associated with the steps S1 to S6.

Next, a universal checkout employ in operation in the system 100 will be described in greater detail. The universal checkout is implemented to employ a method including following steps:
Step Z1: adding selected commodities, for example products or services, or both, into a virtual basket of the graphical user interface (GUI) 300, on a publisher website via one or more of:
   (a) buy buttons of images;
   (b) buy buttons on videos;
   (c) shoppable links;
   (d) storefronts of a virtual shop at a publisher's Internet® website;
   (e) shoppable advertisements provided on the graphical user interface (GUI) 300; and
   (f) any other way that a plugin has an API that the publisher can use themselves to create shoppable experiences for the user.
Step Z2: sending the virtual basket to an API of the system 100:
Step Z3: arranging for the API to return billing and shipping data fields in a unique and normalized manner, the data field provided all information required for supplying the requested commodities; optionally, the data fields are implemented in a dynamic manner;
Step Z4: arranging for a plugin to send billing and shipping information to the API;
Step Z5: arranging for the plugin to request information that is indicative of shipping methods that are available for commodity supplier websites and arranging for the plugin to return the requested information per commodity supplier Internet® website, wherein the plugin groups the information into groups; the system 100 employs a backend that adds the request information to the virtual cart in a webshop that is presented to the user on the graphical user interface (GUI) 300, for example via an affiliate link so that the publishers obtain a commission for their publishing activities;
Step Z6: arranging for the user, for example a visitor, to choose a shipping method for user-selected commodities;
Step Z7: using the plugin to show on the graphical user interface (GUI) 300 available payment methods that are available per Internet® website;
Step Z8: arranging for the user, for example the visitor, to enter payment information, wherein there is optionally further performed one or more of:
   (a) a verification payment for a first site, wherein a corresponding verification link allows for local verification to be performed;
   (b) a saving of order information identifications on a database of the system 100; and
Step Z9: providing a notification to the user via the graphical user interface (GUI) 300 that checkout has been completed.

Optionally, in the system 100, there is employed an internal e-mail for checkout purposes, and all e-mails are forwarded to the user involved with ordering commodities via the system 100. By employing such internal e-mails, it is feasible to monitor an e-mail inbox and apply various filters to filter out order confirmation e-mails; orders are saved in the aforementioned database of the system 100. Optionally, conversion codes are run in the system 100 when executing the steps Z1 to Z9.

Next, auto-scanning implemented within the system 100 will be described in greater detail; such auto-scanning employs a “ScanTag”. Thus, a feature of a given plugin employed in the system 100 a functionality to scan Internet® webpages for potentially interesting images of commodities, and then to proceed to add matching commodities via buy-buttons that are presented via the graphical user interface (GUI) 300. Beneficially, as aforementioned, artificial intelligence (AI) algorithms are employ for implementing the auto-scanning.

Optionally, aforementioned auto-scanning is implemented in the system 100 by employing a method having following steps:
Step W1: arranging for a given publisher to define filters within a dashboard provided by an operator of the system 100;
Step W2: using a plugin associated with the system 100 to scan images of Internet® websites that are provided with the plugin for identifying potential matches against the defined filters of the Step W1, and then sending these potential matches to an API of the system 100, provided that the image is manually tagged with buy buttons presentable on the graphical user interface (GUI) 300; otherwise, there are employed one or more AI algorithms (software) to try to match commodities in relation to which of the commodities are in stock, and commodity retailers that are currently connected to a given account; and
Step W3: arranging for the API to return shoppable images, defined by an image URL (universal resource locator), commodity details and associated buy button coordinates.

Next, the system 100 employs a plugin, for example as aforementioned, that is operable, namely configured, to provide a “convert-a-link” functionality. The plugin is thus operable, namely configured, to scan URL's on a given Internet® webpage based upon a “regex”; a “regex” is a list of commodity retailer domain names (for example in a manner of an Internet® website address directory). The regex is based upon connected publishers that provide a “ON CLICK” functionality at their Internet® web-sites. The regex pertains to a click page, not a load page, for example, for a given Internet® web-site.

When providing “convert-a-link” functionality, there is sent a URL to the API of the system 100; if the URL is detected to pertain to a commodity (for example, a product or service, or both), and the commodity is in stock, there is then opened a plugin of the system 100, and an associated cookie is dropped into a local browser, such that checkout via an associated publisher's Internet® website can be implemented. Optionally, the commodity is also added to the aforementioned fast queue.

In an event that the aforementioned “convert-a-link” functionality does not discover a match in the API of the system 100, there is employed a default response involving opening a new window, wherein a given publisher is able to customize an alternative action, for example by hiding a link if a given commodity is not available, for example by presenting an error message.

The aforementioned system 100 is susceptible to providing a “storefront” to users, in a manner that superficially similar to a real store front in, for example, a shopping mal. The storefront is convenient provided by way of execution of the aforementioned plugin, wherein the plugin allows publishers to turn their web-site into fully functional web-shops; this avoids a need for publishers to redesign their web-sites to provide on-line supply ordering functionality, for example Internet®-supported purchase of products or services, or both. The storefront is capable, for example, of being overlaid onto social media web-sites such as Facebook® or similar.

The plugin, in operation, can be regarded as providing a “layer” over an actual given publisher's web-site, thereby avoiding a need for physical integration for adding the “storefront” to the publisher's web-site. Such a manner of operation is hugely saving in human time and financial cost when designing and implementing a given Internet® site, or adapting an existing we-site to provide it effectively with additional functionality.

Once the “storefront” is activated on a given publisher's web-site, a given user (for example visitor) will potentially have access to a complete full-screen web-shop on top of the publisher's website; there is thereby enabled one or more functionalities of browsing commodities (for example, products) by using selection filters, searching for commodities (for example, products), for ordering commodities (for example, for ordering products) and so forth.

From a given publisher's viewpoint, implementing the system 100 in respect of their published web-site avoids a need for implementing shop software (as conventionally required), there is no need to do one or more deals with retailers, and so forth. Thus, products for supply are selected from an inventory, for example a Monotote™ directory, and then purchase and supply of the products can commence in a manner that is efficient with regard to data flows in communication networks, and in a manner with enhanced temporal responsiveness for users. A further benefit of implementing the system 100 using a separate layer in the publisher's web-site is that unexpected interaction between features of one layer with another are reduced, thereby providing for stable and reliable software execution. Reliable software execution upon computing hardware is a technical issue, and has been the subject matter of many granted patents before the UKIPO, EPO and USPTO.

Thus, as aforementioned, the “storefont” functionality of the system 100 enables, potentially, every web-site on the Internet® to be converted into a webshop, with enormous financial implications for operation of the Internet®. Example designs of such a “storefront” are provided at:

https://drive.google.com/drive/u/3/folders/0Bzb0gcPmz-rneDVtbmJiZGY4Tjg
whose contents are hereby incorporated by reference.

Next, “shoppable links” that are optionally provided by the system 100 will be described in greater detail.

The aforesaid plugin is optionally provided with “shoppable links” and are beneficially installed at publisher's web-sites (namely, for example, are incorporated into HTML code that is used for implementing web-sites, whether directly or via “drag-and-drop” web-site design tools such as Wix®). Beneficially, such “shoppable links” are implemented via additional data that is added onto an end of a website URL (universal resource locator), for example:

http://www.thepublisherswebsite.com/™monotote-product|129MG-10065748-RED

Such a “shoppable links” feature is also beneficially used within internal operation of the system 100 to provide handling of operating status, for example “abandoned cart e-mail”, “re-adding products to cart”, and so forth. The feature is susceptible to reducing user fatigue when using the system 100 to implement a supply of one or more commodities. Optionally, the system 100 supports a hosted marketplace which avoids a given publisher from having to host the plug-in, for example when implementing “shoppable links”.

The system 100 is also, for example, susceptible to being used with other types of social media platforms, for example Instagram®. Thus, the system 100 is capable of being configured to collect automatically Instagram posts based upon one or more user-defined hashtags; thus, there is provided a shopping functionality via use of unique short URL's, for example:

https://bit.ly/wfh38
redirects a visitor to
https://web.monotote.com/instagram/shop/shopmylook?publisher id=12345
which collects all of a given user's Instagram® posts automatically, that are tagged with #shopmylook.

It will be appreciated that court decisions in United Kingdom courts, for example Macrossan & Telco, Aerotel and CVON decisions, relate to business methods as such that are excluded pursuant to section 1(2) PA77 from patentability; in contradistinction, embodiments of the present disclosure provide technical benefits as described in the foregoing, and also address technical problems of data flows within data communication networks and also speed to operation of the data communication networks for implementing given user-defined tasks. It will also be appreciated that that UKIPO, EPO and USPTO authorities regularly grant patent rights in respect of data encoders and decoders that are operable to manipulate bits of data, even though input data may be of an abstract nature (for example, computer-generated graphics), rather than sensor-captured data. In other words, the UKIPO, EPO and USPTO consider a change of entropy of data to be a technical effect when combined with storage and/or communication of the encoded data.

Embodiments of the present disclosure are also operable to change the entropy of data to be communicated in the system 100, for example by use of an aforementioned “layered” approach for implementing the system 100, and therefore provide a corresponding technical effect that a patented encoder or decoder is operable to provide. To assert otherwise would be inconsistent and prejudicial examination of patent application content, and associated grant of patent rights.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for supplying commodities, characterized in that the system is operable to communicate data within a data communication network, and is configured to generate content including one or more images or videos, and one or more symbols that are overlaid onto the one or more images or videos when a rendering of the content occurs on a graphical user interface, wherein the generation of the content reduces an amount of data needed to be communicated within the data communication network, wherein the one or more symbols are user-selection executable via a user action at the graphical user interface, wherein the one or more symbols when selected causes one or more software objects to be executed in the same rendering on the graphical user interface to cause a purchase of one or more associated commodities, in an event that the one or more commodities are in stock for delivery, and wherein the system includes a server that is communicably coupled to computing devices associated with a content publisher and a commodity retailer for generating the content.

2. The system of claim 1, wherein the generated content is encrypted and/or obfuscated within the system, so that third-party malicious hacking of the system to redirect users to bogus or fraudulent web-sites is resisted.

3. The system of claim 2, wherein the generated content, when communicated, is encrypted to generate encrypted data that is then obfuscated by bit, nibble or byte swapping according to an obfuscation template arrangement to generate corresponding obfuscated encrypted data for communication; upon receipt of the obfuscated encrypted data, for presenting the generated content to a given user, the obfuscated encrypted data is processed by de-obfuscation using the obfuscation template arrangement to generate de-obfuscated encrypted data, and then subjecting the de-obfuscated encrypted data to decryption to regenerate the content.

4. The system of claim 3, wherein the obfuscation template arrangement is adaptively selected from a plurality of potential obfuscation template arrangements, depending on one or more of:
(i) one or more characteristics of the given user;
(ii) a technical nature of the content; and
(iii) a commercial value associated with one or more commodities represented by the content.

5. The system of claim 1, wherein the user action includes at least one touch action or click action to be performed on the graphical user interface for selecting the one or more symbols.

6. The system of claim 1, wherein the server, when in operation, directs a user device to the commodity retailer for providing information associated with a user to the commodity retailer.

7. The system of claim 1, wherein the server employs one or more artificial intelligence (AI) algorithms to recognize the one or more associated commodities in one or more images or videos.

8. The system of claim 7, wherein the artificial intelligence algorithms are further operable to overlay the one or more symbols onto the recognized one or more commodities.

9. The system of claim 1, wherein the selection of the one or more symbols renders a user-interaction window on a portion of the same graphical user interface, wherein the user-interaction window enables one or more associated commodities to be purchased, via execution of the one or more software objects via the user action.

10. A method of using a system that is operable to communicate data within a data communication network, and is operable to generate content including one or more images or videos, and one or more symbols that are overlaid onto the one or more images or videos when a rendering of the content occurs on a graphical user interface, wherein the system includes a server that is communicably coupled to computing devices associated with a content publisher and to a commodity retailer for generating the content, wherein the generation of the content reduces an amount of data needed to be communicated within the data communication network, wherein the method includes:
(i) arranging for the one or more symbols to be user-selection executable via a user action at the graphical user interface; and
(ii) arranging for the one or more symbols when selected to cause one or more software objects to be executed in the same rendering on the graphical user interface to cause a purchase of one or more associated commodities, in an event that the one or more commodities are in stock for delivery.

11. The method of claim 10, wherein the method includes arranging for the generated content to be encrypted and/or obfuscated within the system, so that third-party malicious hacking of the system to redirect users to bogus or fraudulent web-sites is resisted.

12. The method of claim 11, wherein the generated content, when communicated, is encrypted to generate encrypted data that is then obfuscated by bit, nibble or byte swapping according to an obfuscation template arrangement to generate corresponding obfuscated encrypted data for communication; upon receipt of the obfuscated encrypted data, for presenting the generated content to a given user, the obfuscated encrypted data is processed by de-obfuscation using the obfuscation template arrangement to generate de-obfuscated encrypted data, and then subjecting the de-obfuscated encrypted data to decryption to regenerate the content.

13. The method of claim 12, wherein the obfuscation template arrangement is adaptively selected from a plurality of potential obfuscation template arrangements, depending on one or more of:
(i) one or more characteristics of the given user;
(ii) a technical nature of the content; and
(iii) a commercial value associated with one or more commodities represented by the content.

14. The method of claim 10, wherein the method includes arranging for the user action to include at least one touch action or click action to be performed on the graphical user interface for selection of the one or more symbols.

15. The method of claim 10, wherein the method includes arranging for the server to direct a user device to the commodity retailer for providing information associated with a user to the product retailer.

16. The method of claim 10, wherein the method includes arranging for the server to employ one or more artificial intelligence (AI) algorithms to recognize the one or more associated commodities in one or more images or videos.

17. The method of claim 16, wherein the method includes arranging for the one or more artificial intelligence (AI) algorithms to be further operable to overlay the one or more symbols onto the recognized one or more commodities.

18. The method of claim 10, wherein the method includes arranging for the selection of the one or more symbols to render a user-interaction window on a portion of the same graphical user interface, wherein the user-interaction window enables the purchase of the one or more associated commodities via execution of the one or more software objects via the user action.

19. A software product recording on machine-readable data storage media, characterized in that the software product is executable upon computing hardware for implementing a method as claimed in claim 10.

20. A graphical user interface arrangement for implementing content and its one or more symbols, together with one or more corresponding executable software objects when invoked by user selection of the one or more symbols, to provide for user action purchasing and delivery of one or more commodities associated with the one or more symbols overlaid upon images of the one or more products included in the content.

21. The graphical user interface of claim 20, wherein the selection of the one or more symbols causes rendering of a user-interaction window on a portion of the same graphical user interface, wherein the user-interaction window enables the purchase of the one or more associated products with the execution of the one or more software objects via the user action.

22. A method of using a graphical user interface arrangement implemented with content including one or more images or videos, and one or more symbols that are overlaid onto the one or more images or videos, wherein the method includes:
(i) arranging for the one or more symbols to be user-selection executable via a user action at the graphical user interface; and
(ii) arranging for the one or more symbols when selected to cause one or more software objects to be executed in the same graphical user interface to cause a purchase of one or more associated products, in an event that the one or more products are in stock for delivery.

23. The method of claim 22, wherein the selection of the one or more symbols causes rendering of a user-interaction window on a portion of the same graphical user interface, wherein the user-interaction window enables the purchase of the one or more associated products with the execution of the one or more software objects via the user action.
